(19) United States
(12) Patent Application Publication
(10) Pub. No.: US 2012/0078752 A1
(43) Pub. Date: Mar. 29, 2012

(54) TRANSACTION IDENTIFIED HANDLING SYSTEM

(75) Inventors: Stefan Hultberg, Stockholm (SE); Magnus Westling, Stockholm (SE)

(73) Assignee: ACCUMULATE AB, Stockholm (SE)

(21) Appl. No.: 13/321,760

(22) PCT Filed: May 17, 2010
(86) PCT No.: PCT/SE10/50532

§ 371 Date: Dec. 8, 2011

(30) Foreign Application Priority Data
Jun. 4, 2009 (SE) 0950407-7

(51) Int. Cl. G06Q 30/06

(52) U.S. Cl. 705/26.41

(57) ABSTRACT

The present invention relates to methods, a transaction router (28) and a transaction handling system comprising a transaction router (28) and at least one transaction server (12) where a transaction identifier is announced to the transaction router. This simplifies the locating of presumptive transaction parts, transaction server and service providers, in order to perform transactions and transaction related activities.

### FIELD OF INVENTION

The present invention relates generally to transactions, and particularly to secure transactions utilizing a portable radio communication device, such as a mobile phone, personal digital assistant, portable computer or similar.

### BACKGROUND

It is today common with transactions initiated and performed via e.g. Internet. Further, with mobile phones or similar devices it is today possible to perform transactions and related actions through data communication via wireless communication. This provides for a very neat way of performing secure transactions, by always having an electronic authentication device at hand, which could be used as a secure wallet/bank solution. However, this also provides for a variety of ways to manipulate the transaction systems in order to fraud one or both of the parts in a transaction.

Such transactions have to be handled in a device, like a transaction server

However it may in relation to this be hard to locate a transaction server that handles a specific transaction, especially if there exist many such transaction servers.

### SUMMARY OF THE INVENTION

An object of the present invention is thus to simplify finding a transaction server that handles a specific transaction or activities in relation to a specific transaction.

This object, among others, is according to the present invention attained by a method, a transaction router and a transaction handling system as defined by the appended claims.

The invention provides a method, a transaction router and a transaction handling system, where a transaction identifier is announced to the transaction router. This simplifies the locating of presumptive transaction parts, transaction servers and service providers, in order to perform transactions and transaction related activities.

According to a variation of the invention a use of a transaction identifier is only verified through a user being activated on a transaction server, which improves the security of the use.

Further security may be obtained through requiring the user to directly verify the use.

Through both transaction parts independently approving the transaction, an even higher security is obtained.

The high security can also be extended to use of items purchased in a transaction for increasing the safety of the user.

The transaction identifier may be kept unique only during a specific transaction, whereby the necessary amount of transaction identifiers can be kept very low at the transaction server, being limiting only for handling parallel transactions at the transaction server.

The unique transaction identifier may be created upon request from the first transaction part, which provides for an assured solution for the first transaction part. Further, for e.g. Internet bank login a predefined transaction identifier may be used.

Further features and advantages of the present invention will be evident from the following description.

### BRIEF DESCRIPTION OF THE DRAWINGS

The present invention will become more fully understood from the detailed description of embodiments given below and the accompanying figures, which are given by way of illustration only, and thus, are not limitative of the present invention, wherein:

FIG. 1 schematically shows a number of devices that may communicate with each other in relation to verifying the use of a transaction identifier,

FIG. 2 schematically shows method steps performed by a transaction server for initiating a transaction session with an application provided by transaction software in a portable radio communication device,

FIG. 3 schematically shows method steps performed by a transaction server in relation to a transaction between a first transaction part and a second transaction part,

FIG. 4 schematically shows method steps being performed by an transaction router, and

FIG. 5 schematically shows method steps being performed by the transaction server in relation to a user and a service provider.

### DETAILED DESCRIPTION OF EMBODIMENTS

In the following description, for purpose of explanation and not limitation, specific details are set forth, such as particular techniques and applications in order to provide a thorough understanding of the present invention. However, it will be apparent for a person skilled in the art that the present invention may be practiced in other embodiments that depart from these specific details. In other instances, detailed description of well-known methods and apparatuses are omitted so as not to obscure the description of the present invention with unnecessary details.

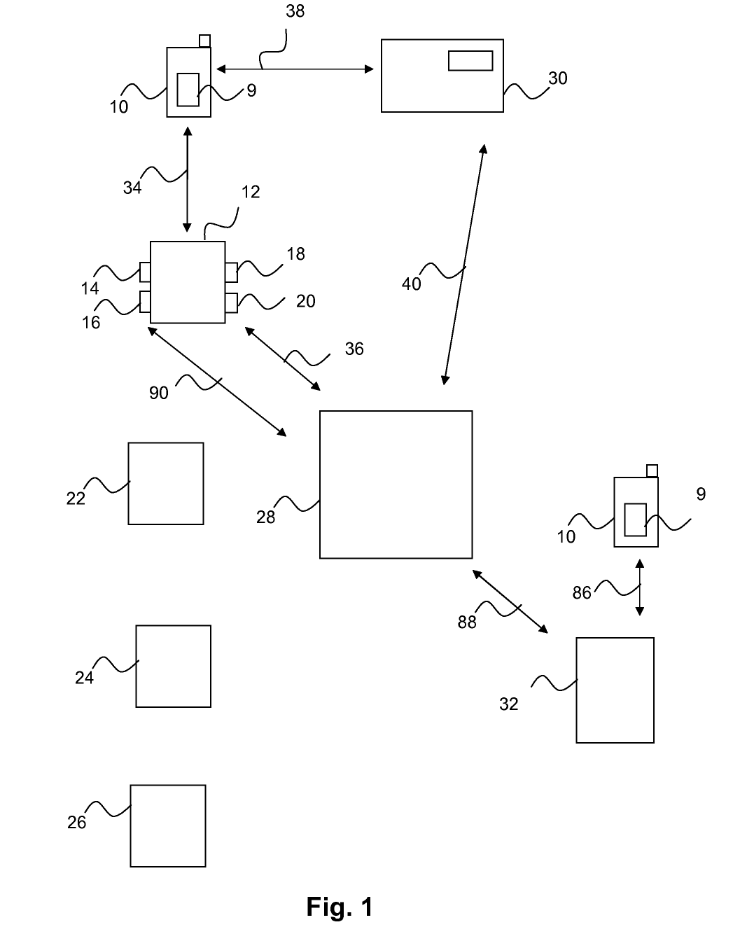

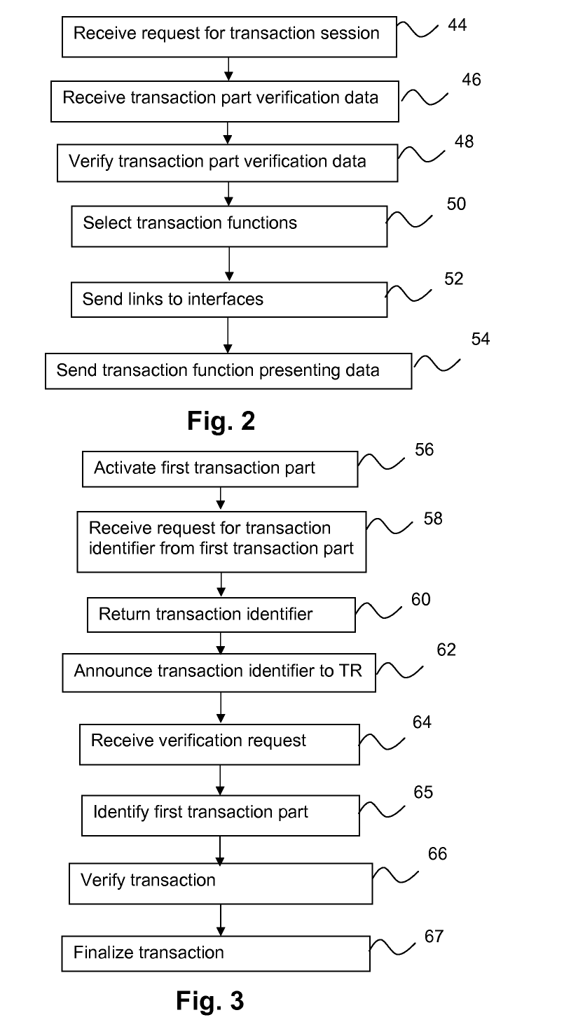

An embodiment of the present invention will now first be described with reference to FIGS. 1 and 2.

In order to secure all links of a transaction, transaction software 9 may be installed in a portable communication device 10 of a user in a secure way, wherein a user is identified in a secure way and tied to the installation. One secure way is to, at e.g. a bank office or other known part, install the transaction software in the portable radio communication device of the user or give a memory card or similar device having an installation program for the user thereon. The identity of the owner of the portable radio communication device is checked in connection with the installation or delivery of the transaction software. Instead of checking the identity directly at a bank office or other known part e.g. a registered letter sent to the intended user can be used to verify the identity of the intended user. Here it is also possible that the identity of the portable radio communication device is registered for later verification. Finally the transaction software is connected to an account at the bank or other part, such as a credit card account, a user account, an electronic wallet, etc. Another secure way to install the transaction software is to, at e.g. an authenticated Internet bank office or similar part, through a secure connection, e.g. a https connection, install the transaction software in the portable radio communication device of the first transaction part. The identity of the owner of the portable radio communication device is checked in connection with the installation through e.g. PIN, which makes up a user identifier. Finally the transaction software is connected to an account at the bank or other part, such as a credit card account, a user account, an electronic wallet, etc. The transaction software being installed typically also has a transaction software identifier.

The transaction software is arranged to communicate with a predefined transaction server 12 when secure transactions are to be performed. Information of which account a transaction software is connected to can be predefined directly at the transaction server or be accessed by the transaction server from the user whenever a transaction is to take place. Account balance and similar checks are preferably performed prior to any finalization of a transaction.

However, there may exist several transaction servers 12, 22, 24 and 26 as is shown in FIG. 1. For this reason there is arranged a transaction router 28 with which these different transaction servers and other parties may communicate. A transaction router and at least one transaction server may here form a transaction handling system.

When a secure Internet installation is utilized a mobile phone number is preferably given to the distribution site, which in response thereto sends a text message, such as an SMS, with a download URL to that mobile phone number, i.e. a so called over the air installation (OTA installation). By following that link in the mobile phone the transaction software is installed in the mobile phone. This phone number may also be used in later verifications. To first start the application run by the transaction software an activation code, given by the distribution site, may be entered. Further, a PIN is also required to be entered to run the application.

After such installing has been made it is then possible to perform transactions. According to the invention, when the application being provided by the transaction software 9 in the phone 10 is started by the user, the user is first asked to enter a user identifier, which may with advantage be a PIN such as the above-descried PIN. The application thus receives the user identity. It is here possible that the transaction application is shut down in case no user identifier is received or is not provided within a pre-determined time.

After this has been done the application optionally fetches a transaction software identifier, i.e. a code identifying the specific copy of the transaction software. The user identifier and the optional transaction software identifier here make up transaction part verification data, i.e. data used to verify a presumptive part of a transaction, which part is normally the user. In this way the application obtains transaction part verification data.

The application then sends a request for a transaction session to the transaction server 12. This request is in this embodiment accompanied by the transaction part verification data, which may furthermore also include a portable radio communication device identifier. This is furthermore sent to the transactions server over an encrypted wireless connection.

When the transaction server receives this request, step 44, and transaction part verification data, step 46, it proceeds and verifies the transaction part verification data, step 48. This here normally involves comparing the received user identifier with the user identifier previously stored for the user, comparing the transaction software identity with the identity of transaction software known to be installed on the portable radio communication device 10 as well as a possible comparison of the portable radio communication device identifier with a previously registered identifier.

In case the comparison indicates that the transaction part verification data was correct, i.e. the transaction part in question is verified, the transaction server 12 selects transaction functions for the user, step 50. These may be a number of transaction functions, the mix of which is customized for the user. The functions may furthermore include new transaction functions that did not exist at an earlier transaction session. The transaction functions are here provided by the transaction server 12 and are furthermore provided by the transaction server through dedicated function interfaces 14, 16, 18 and 20. As an example there are here four transaction interfaces 14, 16, 18 and 20, each being provided through a corresponding API (Application Programming Interface). After the functions have been selected, links to the interfaces of the selected functions are sent to the portable radio communication device, step 52. Such links may be handles, pointers or for instance uniform resource locators (URL). Here the transaction server may also send transaction function presenting data, step 54. Such transaction function presenting data may include instructions on how and where the functions are to be presented via the portable radio communication device, for instance via a display of this device. It is possible that the transaction application is already in possession of such transaction function presenting data, in which case there may be no need for the transmission of it. Also this data is with advantage transferred using an encrypted wireless connection.

The application in the portable radio communication device thus receives 34 the links to the interfaces of the selected transaction functions, and perhaps also transaction function presenting data. Thereafter it presents the transaction functions via the portable radio communication device so that the user can select transaction functions and perform transactions. This may typically be done through presenting a link to the function, through which the user is forwarded to the function on the transaction server. It may also involve presenting a function entry window and a function presenting window, where data entered in the function entry window is transmitted to the function on the transaction server 12 using a received link and data collected from the transaction function via the link is presented in the function presenting window. Such data is also here sent via wireless encrypted communication. In this way there is provided a safe frame within which the user can perform various transactions as well as some other activities to be described later on.

It should here be realized that as a variation of the above described embodiment, the application may first only send the request and provide the transaction part verification data in a later stage after having received a request for such data from the transaction server. In this case it is possible that the user is prompted to enter the user identifier after such a request for transaction part verification data has been received by the application.

The actual carrying out of one transaction will now be described with reference being made to FIGS. 1, 3 and 4.

When a transaction 38 is to take place between two transaction parts, i.e. between two parties in a transaction, where the user is a first transaction part and another party, such as a merchant, is a second transaction part, which may be Internet based, such as an authenticated merchant secure Internet site 30 or a secure login, the transaction comprises the following steps. The user of the portable radio communication device, i.e. the first transaction part, selects a “transaction” function of the transaction software. As the user selects a function, selection data is sent to the interface of the transaction server defined through the associated link. The transaction server 12 thus receives selection data via the function interface. It then starts the corresponding transaction function for the user. In relation to this starting of the transaction function on the transaction server there is an activation of the first transaction part 10 on the transaction server 12, step 56, which activation is performed through encoded/encrypted wireless communication. Thereby the transaction server 12 puts the first transaction part 10 in an active transaction state on the transaction server 12. Activation may as an alternative be performed in relation to the verification of transaction part mentioned above.

The first transaction part 10 preferably stays in the active transaction state on the transaction server 12 until the first transaction part 10 requests a non-active transaction state. Alternatively, the first transaction part 10 will be put into a non-active transaction state by the transaction server 12 after a time-out. Further, the transaction server 12 could also put the first transaction part 10 in a non-active state after finalization of a transaction. By waiting for a request before putting the first transaction part into a non-active state the advantage is obtained that the user can perform several consecutive transactions without having to reselect the “transaction” section of the transaction software. This is however preferably combined with a time out, which gives the advantage that the user does not forget to put the portable radio communication device in a non-active transaction state, which would be risky if another person gets hold of the portable radio communication device. From a secure perspective it would be advantageous to put the first transaction part in a non-active transaction state also after a transaction has been completed.

The first transaction part thereafter initiates the transaction by requesting, through an encoded/encrypted wireless communication, a transaction identifier of the transaction server. The wireless communication can e.g. be performed through GPRS, 3G data, Wi-Fi or WiMAC, all of which could have some kind of built-in identifier verification, and even infrared or Bluetooth, which however are anonymous and could require some added identifier verification. The transaction server receives the request, step 58, then generates a transaction identifier, associates this transaction identifier to the user and responds to the request by sending 34 the generated transaction identifier to the first transaction part, i.e. it returns the transaction identifier, step 60. The transaction identifier is unique during the whole transaction but is preferably reusable after finalization of the transaction, advantageously directly after finalization of the transaction, i.e. when the transaction receipt has been sent.

The transaction server 12 then announces 36 the transaction identifier to the transaction router (TR) 28, step 62. This announcement may optionally comprise a link to the transaction server, apart from the transaction identifier relating to a transaction associated with the first transaction part. The transaction identifier in this case relates to a transaction which the first transaction part is in the process of engaging in. This link therefore identifies the transaction server 12 as well as possibly an API 20, via which the transaction server 12 may be reached for verification purposes.

After having received the announcement, step 68, the transaction router 28, stores the link associated with the transaction identifier.

It should here be realized that also the transaction router may generate the transaction identifier upon request by the transaction server. If the transaction server generates one itself, there may be a collision with already existing transaction identifiers that are in use. If there is such a collision, it is here possible that the transaction identifier generated by the transaction server is put on hold till the exiting transaction identifier expires. Alternatively it is possible to generate the transaction identifier well in advance, for instance before the user requests one, inform the transaction router about the generated transaction identifier in order to ensure that it is not blocked and then announce to the transaction router that the transaction identifier is to be used when a request for transaction identifier has been received from the user.

The first transaction part then enters 38 the returned transaction identifier at a merchant secure Internet site, i.e. the second transaction part 30.

The second transaction part 30 now needs to verify the use of the transaction identifier for finalizing a transaction involving the first and the second transaction part. However this cannot be done directly since there are many transaction servers and it is hard to determine which transaction server is to verify the transaction. Therefore the device 30 of the second transaction part, which device is thus an entity needing to verify the use of the transaction identity, connects to the transaction router 28. It therefore sends 40 a verification request to the transaction router 28 concerning the received transaction identifier for verifying the first transaction part. The request is here a request intended for the unknown transaction server 12.

This verification request is then received by the transaction router 28, step 70, which goes on and identifies the transaction server 12 based on the transaction identifier indicated in the verification request, step 72. It then routes this request to transaction server 12 and possibly to the API 20. In fact, from this point forward it routes all communication regarding the transaction involving the transaction identifier between the transaction server 12 and the second transaction part 30, step 74, for allowing the second transaction part to communicate with the transaction server for verifying the use of the transaction identifier, which use is here a transaction.

The transaction server 12 receives the verification request, step 64. It also receives information of the transaction connected to the transaction identifier, preferably encrypted. The verification request and the information of the transaction could be sent together or separately. Transaction information from the second transaction part that is sent with a transaction can vary, but typically includes the name of the second transaction part and the transaction amount, and possibly also an identifier of the item purchased, such as a product name. The name of the second transaction part could alternatively be extracted from the login of the second transaction part to the system instead of being sent together with the transaction, to ensure that such information is not distorted. This is usually performed via landline communication, but could also be performed via wireless communication. The second transaction part may have previously registered an account at the transaction server, in a way similarly performed for the first transaction part. Account information or similar information of the first transaction part is not necessary to give to the second transaction part and vice versa, since such information is known by the transaction server, and such information should thus not be given to the second transaction part and vice versa.

The transaction server 12 then identifies the first transaction part by the unique transaction identifier sent by the second transaction part, step 65, which may be done through investigating the transaction identifier to see if it is associated with the first transaction part. It then preferably requests 34, through an encoded/encrypted wireless communication, a verification by the first transaction part of the transaction information connected to the transaction identifier. The application provided by the transaction software 9 in the phone 10 requests e.g. a PIN as verification of the transaction information, such as name of the second transaction part and transaction amount. The verification is returned 34, through an encoded/encrypted wireless communication, to the transaction server connected to the transaction identifier.

After verification from the first transaction part the transaction server, verifies the transaction, step 66, then finalizes the transaction connected to the unique transaction identifier, step 67, and sends a transaction receipt to both the first transaction part, through an encoded/encrypted wireless communication, and the second transaction part. The transaction is only finalized provided that the accounts of both the first transaction part and the second transaction part accept the transaction. Here the verification of the transaction by the transaction server may be performed through finalizing of the transaction and sending of the transaction receipt. However, it requires that the first transaction part is active, and here also that it verifies the transaction.

The connection between the transaction server and the first transaction part is, as can be seen in FIG. 1, different from the connection between the transaction server and the second transaction part. This means that the connection paths used are different.

It is possible to perform a transaction between the first and second transaction parts through the merchant requesting a unique transaction identifier of the transaction server, in this case preferably through land line communication. The unique transaction identifier is then communicated to the portable radio communication device from the merchant. However, information of the transaction connected to the unique transaction identifier is again sent from merchant to the predefined transaction server, which, by wireless communication, sends the information of the transaction connected to the unique transaction identifier to the portable radio communication device. The transaction connected to the unique transaction identifier is still verified at the portable radio communication device by a user verification, which verification connected to the unique transaction identifier is sent to the transaction server. The transaction connected to the unique transaction identifier is thereafter finalized based on the information of the transaction and the unique transaction identifier, and a transaction receipt of the finalized transaction is sent from the transaction server to the first and second transaction parts. Also in this reverse the first transaction part has put itself in an active transaction state on the transaction server. Without the first transaction part being in the active transaction state the transaction will not be finalized.

It is possible to vary the way transactions are performed. Instead of requesting a transaction identifier from the transaction server a predefined identifier may be utilized, known by both the first transaction part and the transaction server, such as a social security number, account number or similar. This can be used for e.g. Internet bank login, or other kinds of secure login or secure authentication. The user acting as the first transaction part preferably enters this predefined identifier at the premises of the second transaction part and thereby initiates the login at the second transaction part. Alternatively the first and second transaction parts are e.g. equipped with electronic communication means, providing the possibility for the first transaction part to enter the predefined identifier at the second transaction part without the user needing to perform it manually. The user of the first transaction part also selects a “secure login” section of the transaction software to connect the portable radio communication device to the transaction server and thereby puts the first transaction part in an active transaction state on the transaction server.

As the first transaction part is here put in an active state, the transaction server is informed that a transaction is to take place. The first transaction part may here indicate to the transaction server that it uses a pre-defined transaction identifier. The transaction server may here also know this because no transaction identifier has been requested.

As the transaction server in this way knows that a transaction is to take place using the pre-determined transaction identifier, it now sends an announcement to the transaction router. This announcement comprises the pre-defined transaction identifier associated with the first transaction part.

After having received the announcement, the transaction router, stores the transaction identifier associated with the transaction server.

The second transaction part does again not know which transaction server to connect to for verification purposes. It therefore sends a verification request to the transaction router concerning the transaction identifier for verifying the first transaction part.

This verification request is received by the transaction router, which locates the transaction server and thereafter routes all traffic between the second transaction part and the transaction server concerning the transaction.

As an alternative it is possible that instead the second transaction part announces a transaction identifier to the transaction router, which announcement comprises the pre-defined transaction identifier. This is then stored by the transaction router together with data identifying the second transaction part.

In this case the transaction server, which knows that a transaction is to take place because the first transaction part is active but has not requested any transaction identifiers, connects to the transaction router looking for the pre-determined transaction identifier of the first transaction part. The transaction server then sends a first verification request to the transaction router concerning the transaction identifier for verifying the first transaction part. The first request is here a request for a second transaction part to connect itself so that a verification can be carried through.

This verification request is received by the transaction router, which forwards it to the second transaction part.

Thereafter the second transaction part sends a second verification request to the transaction server and requests a verification connected to a login of the first transaction part, based on the predefined identifier. The transaction server checks that the portable radio communication device corresponding to the predefined identifier is connected to the transaction server, at least by checking that the first transaction part is in an active transaction state on the transaction server. The transaction server preferably additionally requests a verification connected to the login from the first transaction part, or alternatively checks that the portable radio communication device of the first transaction part is on, which is performed without any active action by the user thereof.

The verification in the portable radio communication device is e.g. a PIN. The transaction server will when the first transaction part is in the active state, or after verification when used, send a verification to the second transaction part confirming that the portable radio communication device has been verified, which will allow log in of the first transaction part into the second transaction part. In this case no PIN or other password has been transferred via the Internet connection. Further, the PIN has not been transferred between the transaction server and the second transaction part. The second transaction part only receives a confirmation that the identification is verified. Transactions at the second transaction part can hereafter be performed as previously described.

Examples of different transaction are e.g. point of sales (POS) transaction, person to person (P2P) transfer, micro payments, person to machine (vending machine) transaction, secure identification, electronic identification, secure authentication, etc.

At such a transaction it is possible that the first transaction part, i.e. the user, purchases an item, like an object or a service, provided by a service provider. Such an item may for instance be a ticket, for instance in the form of an image, which may be stored by the transaction server. Such an item may then later be transferred to the application in the transaction software of the portable radio communication device as the user requests a transaction session by starting the application. This has the advantage of providing the item in the context of a safe frame following proper identification of the user. The item may also be stored in a third-party system such as the system of the service provider and retrieved from there when the user needs to use the item. In order to verify that that it actually is the user that fetches the item from this third-party system, the storing may be linked to a user identifier, like a pre-defined transaction identifier of the user or the transaction software identifier.

It is according to a variation of the invention possible that the user links a transaction identifier to this item. He or she may thus request the transaction server to link a transaction identifier to the purchase. The transaction identifier may thus be associated with the service provider or with an item, service or object, such as a ticket. The transaction identifier may here be the same transaction identifier used for the purchase, either transaction server generated or pre-defined. It is also possible that a new transaction identifier is provided, which may be either a transaction server generated or pre-defined transaction identifier.

However, there are many advantages associated with a pre-defined transaction identifier. Since the user is equipped with a portable radio communication device, this may be used in several ways for providing a pre-defined transaction identifier. This phone may for instance be provided with an RFID unit or EAN code that includes the pre-defined transaction identifier. This can be used with advantage for the user in relation to a number of different services.

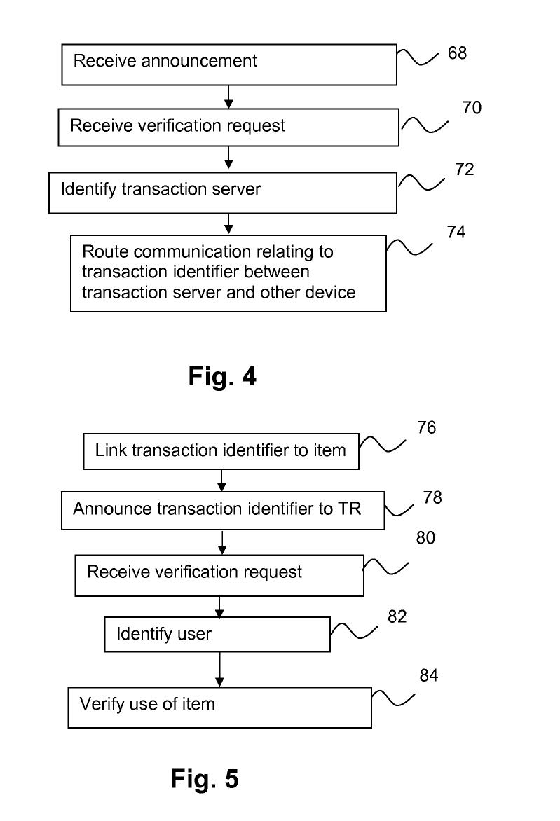

With reference being made again to FIGS. 1 and 4, this time together with FIG. 5, therefore according to this variation of the invention, the transaction server 12 after having linked a transaction identifier to a purchased item, step 76, sends 36 an announcement to the transaction router TR 28, step 78. This announcement involves an announcement of the transaction identifier relating to a transaction associated with the user and optionally a link to the transaction server 12. The transaction identifier in this case thus relates to a previously performed transaction by the user when acting as a first transaction part. This link therefore identifies the transaction server 12 as well as optionally an API 16, via which it may be reached for verification purposes.

After having received the announcement, step 68, the transaction router 28, stores the link for the transaction identifier.

As the user now moves to an area where the purchased item may be used, for instance at an entrance to an underground station or a movie theater associated with the service provider from where the item was purchased. The portable radio communication device 10 may then be brought close to for instance an RFID reader, which reads 86 the transaction identifier. This may be combined with the user showing the ticket.

Such a reader is then connected to a service provider object reading system 32, which thus is a service provider device. It should be noted that this is just one way in which the transaction identifier may be provided to the service provider device.

The service provider now has a transaction identifier, but needs to find out which transaction server that verifies it. This may be needed in order to assess whether a purchased item, object or service, is a legitimate item.

Therefore the service provider device 32 connects to the transaction router 28. It therefore sends 88 a verification request to the transaction router for verifying the use of the transaction identifier.

This verification request is then received by the transaction router 28, step 70, which identifies that the transaction server 12 is to receive the request based on the association with the transaction identifier, step 72. The transaction router then forwards 90 the verification request to the transaction server 12. In fact it routes all communication between the transaction server 12 and the service provider 32 that concerns the transaction identifier, step 74.

The transaction server 12 then receives the verification request, step 80, and may now investigate the transaction identifier. It may thus identify the user through the transaction identifier, step 82, and thereby verify the use of the item, step 84. It can in one embodiment of the invention directly verify the use of the transaction identifier only based on the transaction identifier itself. The request may here also include item related data, such as the name of the service provider. This item data may furthermore also be investigated for correspondence. The user is then only verified in case the item is the same. It is here furthermore possible to, instead or in addition, investigate if the user is active. Again the user is only verified if all checks match. It is here also possible that the user is informed through the application provided by the transaction software in the portable radio communication device about the verification of the use of the item. The user may then respond by giving a yes/no answer or entering a verification code. Verification of the use is then made based on a correct response. It is here preferred that verification of the use is only made if at least the user is active.

The transaction server 12 thereafter returns 90 a verification of the use of the transaction identifier, which is here actually a use of the purchased item and the service provider may then allow the use of the item.

This has the advantage of providing enhanced security for a user when acting as a first transaction part and also in relation to the use of purchased items. This is combined with an ease of use for the user. If for instance a ticket is used, which may be stolen or copied by a fraudulent part, the fraudulent use of such a ticket is avoided since it has to be combined with verifying the user. This security is enhanced if the user has to be active for the use to be verified.

Through the invention it is furthermore easier for parties involved in a transaction to locate each other. This is especially important if there are many possible transaction parts, many transaction servers and many service providers.

The various devices described here may each be realized through the use of one or more processors together with memory including computer program code carrying out the functionality of the device when being run by such a processor.

The description above was made in relation to a single transaction router in order to provide a better understanding of the present invention. It should however be realized that it is in fact possible with several transaction routers, for instance for various types of services.

It will be obvious that the present invention may be varied in a plurality of ways. Such variations are not to be regarded as departure from the scope of the present invention as defined by the appended claims. All such variations as would be obvious for a person skilled in the art are intended to be included within the scope of the present invention as defined by the appended claims.

1-16. (canceled)

17. A method for locating a transaction server associated with a user and the use of a transaction identifier provided in relation to a transaction made by said user, comprising the steps of:
receiving, in a transaction router, an announcement from a first device, said announcement concerning a transaction identifier relating to a transaction associated with the user:
receiving, in the transaction router, a verification request from a second device, said verification request concerning the transaction identifier for verifying the user;
identifying, by the transaction router, the first device based on the transaction identifier indicated by the verification request; and
routing communication relating to the transaction identifier between the first and second device for verifying the use of the transaction identifier;
where one of the devices is a transaction server and the other device is an entity needing to verify the use of the transaction identifier.

18. A method according to claim 17, further comprising the steps of
receiving in the transaction server, the verification request, said request including the transaction identifier;
identifying, by the transaction server, the user through said transaction identifier; and
verifying, by the transaction server, the use of the transaction identifier for the other device based on the identification.

19. A method according to claim 18, further comprising the steps of receiving, by the transaction server, an activation request from the user via a portable radio communication device of said user, said activation request being a request for activating the user on said transaction server, putting, by the transaction server, the user in an active state on said transaction server, where the step of verifying the use of the transaction identifier is only performed if the user is active.

20. A method according to claim 19, further comprising the step of sending a request to the user to verify the use of the transaction identifier and receiving a user verification of said use connected to said transaction identifier from said user, where the step of verifying the use of the transaction identifier is only performed if the user also verifies the use.

21. A method according to claim 19, said activation request being a request for initiation of the user as a first transaction part on said transaction server resulting in the transaction server putting the user in an active transaction state as a first transaction part, the method further comprising the steps of
receiving, in the transaction server from said other device, information of a transaction connected to said transaction identifier, sent from said second transaction part to said transaction server;
finalizing, by the transaction server, said transaction connected to said transaction identifier based on said information of said transaction and said transaction identifier; and
sending, from the transaction server, a transaction receipt of the finalized transaction connected to said transaction identifier to said first transaction part via the portable radio communication device and to said second transaction parts via the transaction router;
wherein the step of verifying the use of the transaction identifier comprises verifying the transaction.

22. The method as claimed in claim 21, further comprising the steps of:
sending, by encrypted wireless communication, said information of said transaction connected to said transaction identifier from said transaction server to said first transaction part; and
receiving a user verification of said transaction connected to said transaction identifier from said first transaction part.

23. The method according to claim 18, wherein the first device is a transaction server and the second device is a service provider device, associated with a service provider from which said user has purchased an item via said transaction server, the method comprising the further steps of—linking, in the transaction server, said transaction identifier to the item in relation to the service provider;
wherein the step of verifying involves verifying a use of the item by the user.

24. The method according to claim 17, wherein said transaction identifier is created based on a request from said first transaction part and sent to said first transaction part.

25. The method according to claim 17, wherein said transaction identifier is a unique transaction identifier and reusable for another transaction after the transaction receipt has been sent.

26. The method according to claim 17, wherein said transaction identifier is predefined and known by said transaction server and said first transaction part.

27. The method according to claim 19, wherein communication between the transaction server and the user is performed using encrypted wireless communication.

28. The method according to claim 27, wherein the activation request is a request for a transaction session sent from a portable radio communication device associated with the user and further comprising the steps of:
receiving, in the transaction server, transaction part verification data from said portable radio communication device;
verifying the transaction part verification data;
selecting a number of transaction functions accessible to the user based on the verification; and
providing the portable radio communication device with links to interfaces of the transaction server where the selected transaction functions are accessible.

29. A transaction router provided for locating a transaction server associated with a user and the use of a transaction identifier provided in relation to a transaction made by said user, said transaction router being configured to:
receive an announcement from a first device, said announcement concerning a transaction identifier relating to a transaction associated with the user;
receive a verification request from a second device, said verification request concerning the transaction identifier for verifying the use of the transaction identifier;
identify the first device based on the transaction identifier indicated by the verification request; and
route communication relating to said transaction identifier between the first and the second device for verifying the use of the transaction identifier,
where one of the devices is a transaction server and the other device is an entity needing to verify the use of the transaction identifier.

30. A transaction handling system including
a transaction router provided for locating a transaction server associated with a user and the use of a transaction identifier provided in relation to a transaction made by said user, said transaction router being configured to:
receive an announcement from a first device, said announcement concerning a transaction identifier relating to a transaction associated with the user;
receive a verification request from a second device, said verification request concerning the transaction identifier for verifying the use of the transaction identifier;
identifying the first device based on the transaction identifier indicated by the verification request; and
route communication relating to the transaction identifier between the first, and the second device for verifying the use of the transaction identifier.
a transaction server being one of the devices where the other represents an entity needing to verify the use of the transaction identifier, the transaction server being configured to
receive the verification request, said request including the transaction identifier;
identify the user through said transaction identifier; and
verify the use of the transaction identifier to the other device based on the identification.

31. A transaction handling system according to claim 30, the transaction server being further configured to:
receive an activation request from the user via a portable radio communication device of said user, said activation request being a request for activating the user on said transaction server; and
put the user in an active state on said transaction server, where the verification of the use of the transaction identifier is only performed if the user is active.

32. The transaction system according to claim 31, the transaction server being further configured to;
send a request to the user to verify the use of the transaction identifier; and
receive, a user verification of said use connected to said transaction identifier from said user,
where the verification of the use of the transaction identifier by the transaction server is only performed if the user also verifies the use.
